(19) United States
(12) Patent Application Publication
(10) Pub. No.: US 2018/0350216 A1
(43) Pub. Date: Dec. 6, 2018

(54) Generating Representations of Interior Space

(71) Applicant: Google Inc., Mountain View, CA (US)

(72) Inventors: Scott Benjamin Satkin, Menlo Park, CA (US); Ryan Michael Hickman, Sunnyvale, CA (US); Ying Zhang, Cupertino, CA (US); Johnny Chung Lee, Mountain View, CA (US)

(21) Appl. No.: 14/584,108

(22) Filed: Dec. 29, 2014

Related U.S. Application Data
(60) Provisional application No. 61/923,369, filed on Jan. 3, 2014.
(60) Provisional application No. 61/923,353, filed on Jan. 3, 2014.

(51) Int. Cl. G08B 13/196

(52) U.S. Cl. CPC G08B 13/19639

(57) ABSTRACT

Systems and methods for generating or enhancing representations of an interior space using data collected by a device, such as a mobile device, capable of simultaneous localization and mapping. An electronic device, such as a mobile device, can be configured to collect data using a variety of sensors as the device is carried or transported through a space. The collected data can be processed and analyzed to generate geometry data providing a three-dimensional representation of the space and objects in the space in near real time as the device is carried through the space. The geometry data can be used for a variety of purposes, including generating and/or enhancing models and other representations of an interior space, and/or assisting with navigation through the interior space.

### PRIORITY CLAIM

The present application claims the benefit of priority of U.S. Provisional Patent Application No. 61/923,369 filed Jan. 3, 2014, entitled “Generating Representations of Interior Space” and U.S. Provisional Patent Application No. 61/923,353 filed Jan. 3, 2014 entitled “Generating Training Data for Visual Search Application.” The above-referenced patent applications are incorporated herein by reference.

### FIELD

The present disclosure relates generally to processing of data collected by a device capable of simultaneous localization and mapping, and more particularly to generating representations of interior spaces using data collected by a device capable of simultaneous localization and mapping.

### BACKGROUND

The advance of wireless and broadband technology has led to the increased use of mobile devices, such as smartphones, tablets, mobile phones, wearable computing devices, and other mobile devices. Such mobile devices are typically capable of being easily carried or transported by a user and used to perform a variety of functions. Certain mobile devices can have various sensors, such as accelerometers, gyroscopes, depth sensors, and other sensors. These mobile devices can also include image capture devices (e.g. digital cameras) for capturing images of a scene, such as the interior of a building, home, or other space.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method. The method includes obtaining, by one or more computing devices location data indicative of a location of a mobile device in an interior space. The location data can be determined based at least in part from one or more motion sensors associated with a mobile device and a sparse point cloud obtained by the mobile device. The method can further include obtaining, by the one or more computing devices, depth data indicative of the location of one or more surfaces proximate the mobile device. The depth data can be acquired by the mobile device using one or more depth sensors. The method can further include generating a visual representation of an interior space based at least in part on the location data and the depth data.

Other aspects of the present disclosure are directed to systems, apparatus, tangible non-transitory computer-readable media, user interfaces and devices for generating and/or enhancing representations of an interior space, such as the interior of a building.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example device capable of simultaneous localization and mapping according to example embodiments of the present disclosure;

FIG. 2 depicts a graphical representation of an example set of data collected by an example device capable of simultaneous localization and mapping according to example embodiments of the present disclosure;

FIG. 3 depicts a flow diagram of an example method of generating a visual representation of an interior space according to example embodiments of the present disclosure;

FIG. 4 depicts an example device capable of simultaneous localization and mapping mounted to a digital camera according to example embodiments of the present disclosure;

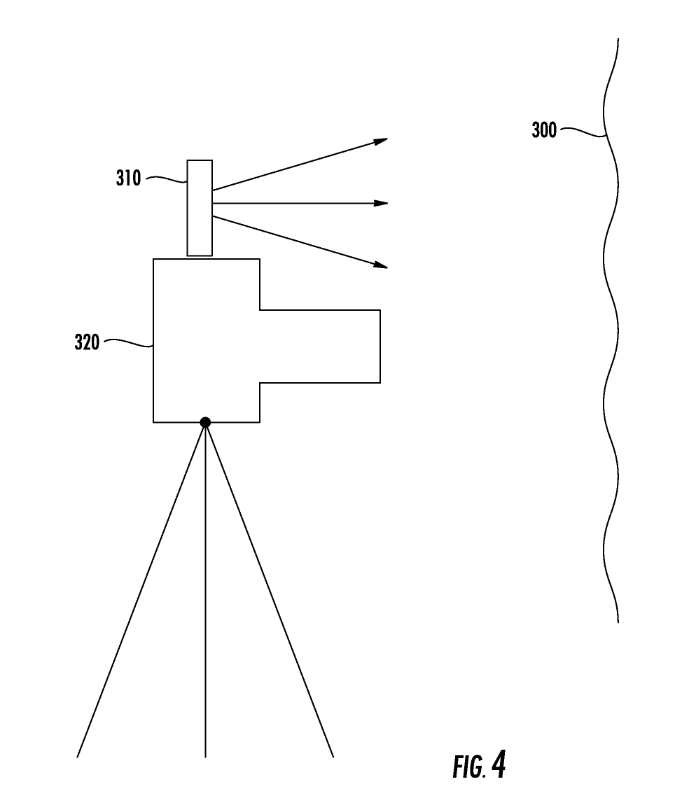

FIG. 5 depicts a flow diagram of an example method for generating a panoramic image of an interior space according to example aspects of the present disclosure;

FIG. 6 depicts a flow diagram of an example method for generating a floor plan of an interior space according to example aspects of the present disclosure.

FIG. 7 depicts the example carrying or transporting of a device capable of simultaneous localization and mapping through an interior space according to example embodiments of the present disclosure;

FIG. 8 depicts an example dense depth map generated of an interior space according to example embodiments of the present disclosure;

FIG. 9 depicts an example floor plan generated of an interior space according to example embodiments of the present disclosure; and

FIG. 10 depicts a flow diagram of an example method of training a visual search application according to example aspects of the present disclosure.

### DETAILED DESCRIPTION

Reference now will be made in detail to embodiments, one or more examples of which are illustrated in the drawings. Each example is provided by way of explanation of the embodiments, not limitation of the invention. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Example aspects of the present disclosure are directed to generating or enhancing representations of a scene, such as an interior space, using data collected by an electronic device capable of simultaneous localization and mapping (a “SLAM device”). Collection of data for generating representations of interior spaces can be tedious and can require significant resources. According to example aspects of the present disclosure, an electronic device, such as a mobile device (e.g. a smartphone, tablet, wearable computing device, autonomous image collection device, etc.), can be configured to generate data using a variety of sensors as the device is carried or transported through a space. The collected data can be processed and analyzed to determine the location of the device in the space and to generate a three-dimensional map of the space in near real time. The data collected and generated by the SLAM device can be used for a variety of purposes, including generating three-dimensional models of scenes using the depth data and images captured by the SLAM device. According to particular embodiments, the three-dimensional models can be used in generating and/or enhancing models and other representations of an interior space and/or assisting with navigation and obstacle avoidance through the interior space. The three-dimensional models can be used for other purposes, such as for generating two-dimensional images of a scene from a plurality of different perspectives for purposes of training a visual search application.

For example, data can be collected from a SLAM device using one or more motion sensors, depth sensors, and image capture devices as the SLAM device is carried through a space. The collected data can include location data indicative of the location of the SLAM device as it is carried through the space and depth data indicative of the depth or distance to surfaces proximate to the SLAM device. The location data and the depth data can be coordinated with one another to generate the three-dimensional map for the space.

In one particular implementation, the location data can be derived from signals from one or motion sensors (e.g. an accelerometer, a gyroscope, and/or other motion sensor) and a sparse point cloud of data points generated by the SLAM device. The sparse point cloud of data points can include a plurality of data points representative of points on surfaces proximate to the SLAM device in the space. The sparse point cloud can be generated, for instance, by capturing imagery (e.g. a video) of the space as the SLAM device is carried through the space. Features can be identified in the images using feature identification techniques. The identified features can be tracked through multiple images acquired of the space as the SLAM device is carried through the space to identify the sparse point cloud using, for instance, structure from motion techniques and/or visual odometry. Each tracked feature can correspond to a point in the sparse point cloud. The SLAM device can be configured to determine its approximate location in the space using signals received from the motion sensors and the sparse point cloud.

The depth data can include a dense depth map providing the approximate depth or distance of surfaces relative to the SLAM device as the SLAM device is carried through the space. The dense depth map can be generated, for instance, using one or more depth sensors. The depth sensors can include laser range finders and/or other suitable depth sensors. In one particular implementation, structured light techniques can be used to generate a dense depth map representative of the geometry of the space proximate to the SLAM device. Structured light techniques can include, for instance, projecting a pattern of pixels on to a surface and analyzing the deformation of the pixels to determine depth data for the surface. The dense depth map can be of high resolution and can include approximate depths for many points along surfaces proximate to the SLAM device.

The depth data can be coordinated with the location data to generate the three-dimensional map for the space. The three-dimensional map can include a plurality of data points indicative of the location of surfaces in the space. The three-dimensional map can include geometry of objects such as furniture, walls, and other objects in the space. In this way, data indicative of the geometry of the interior space (e.g. a building interior) can be obtained as the SLAM device is carried through the space.

Data associated with the scene collected by the SLAM device can be accessed and used to generate a three-dimensional model of the scene. For example, a SLAM device can acquire imagery and depth data associated with a particular scene from a plurality of different perspectives as the SLAM device is carried or transported through the scene. The data acquired by the SLAM device can be used to construct a three-dimensional model of the scene. For instance, a polygon mesh modeling the geometry of the scene can be generated by merging the depth data associated with the plurality of different perspective of the scene captured by the SLAM device. The images of the scene captured by the SLAM device can be texture mapped to the polygon mesh.

In particular embodiments, the data collected by the SLAM device can be used to generate or enhance representations of an interior space, for instance, in a geographic information system. For example, the data captured by a SLAM device can be used to refine the pose of and generate depth data for panoramic images captured of an interior space. As another example, the data captured by a SLAM device can be used to generate floor plans, models of interior spaces, representations of furniture and other objects, and for other purposes. As yet another example, the data captured by a SLAM device can be used to assist with navigation and obstacle avoidance in an interior space.

In still other embodiments, the data collected by the SLAM device can be used to train a visual search application. For instance, a three-dimensional model generated from data collected by the SLAM device can be used to generate a plurality of two-dimensional images of the scene. For instance, the three-dimensional model can be viewed from a plurality of different camera viewpoints. A two-dimensional image of the scene from each camera viewpoint can be generated from the three-dimensional model, for instance, by projecting the three-dimensional model onto an image plane. Once generated, the two-dimensional images can be used to train the visual search application.

Various embodiments discussed herein may access and analyze personal information about users, or make use of personal information, such as data captured by a SLAM device. In some embodiments, the user may be required to install an application or select a setting in order to obtain the benefits of the techniques described herein. In some embodiments, certain information or data can be treated in one or more ways before it is stored or used, so that personally identifiable information is removed. For example, in certain embodiments, a user's identity may be treated so that no personally identifiable information can be determined for the user.

### Example Devices Capable of Simultaneous Localization and Mapping

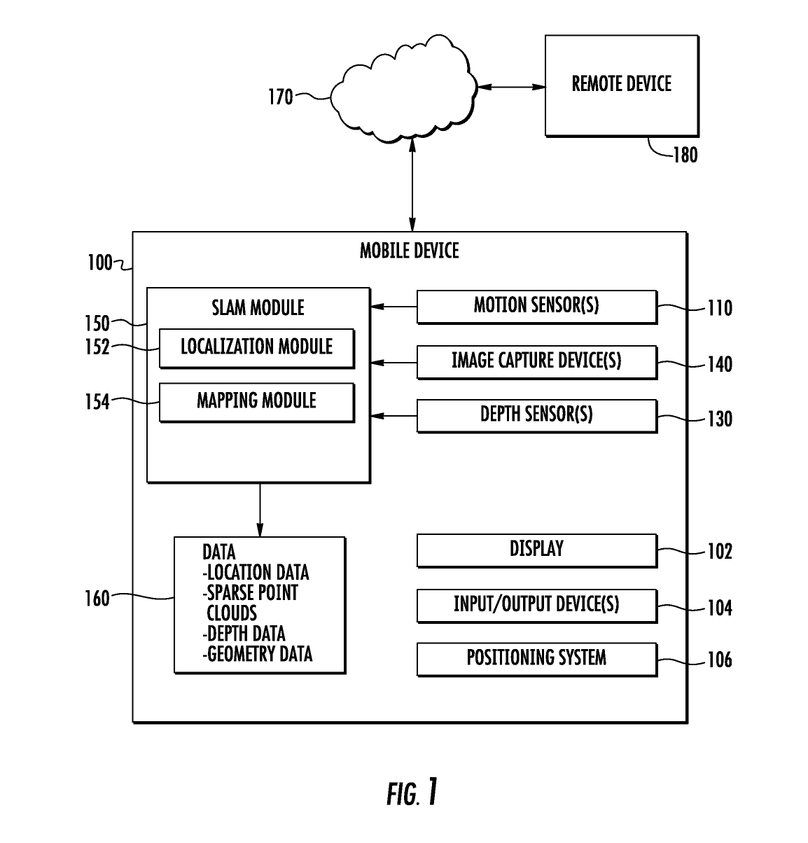

FIG. 1 depicts an example SLAM device 100 capable of simultaneous localization and mapping according to example aspects of the present disclosure. The SLAM device 100 can be any suitable electronic device. In a particular example embodiment, the SLAM device 100 can be a mobile device (e.g. a smartphone, tablet, mobile phone, wearable computing device, autonomous image collection device, etc.) capable of being easily carried or transported by a user (e.g. by the user's hand) while in operation.

The SLAM device 100 can include one or more processors and one or more memory devices including one or more tangible, non-transitory computer-readable media. The computer-readable media can store computer-readable instructions that when executed by one or more processors cause one or more processors to perform operations, such as operations to implement any of the methods or functionality disclosed herein.

As shown in FIG. 1, the SLAM device 100 can include a display 102 (e.g. a touchscreen), various input/output devices 104 for providing and receiving information from a user, such as a touch pad, data entry keys, speakers, and/or a microphone suitable for voice recognition, and a positioning system 106. The positioning system 106 can be configured to determine the position of the SLAM device 100 based on satellite positioning technology, proximity to one or more wireless or cellular network access points, and other positioning techniques.

The SLAM device 100 can include various sensors and other devices for simultaneous localization and mapping of the SLAM device 100. For instance, the SLAM device 100 can include one or more motion sensors 110, depth sensors 130, and image capture devices 140. Signals, images, and information generated by the one or more motion sensors 110, depth sensors 130, and image capture devices 140 can be processed using a simultaneous localization and mapping (SLAM) module 150 to generate and process data 160 associated with the space through which the SLAM device 100 is carried.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible non-transitory computer-readable storage medium such as RAM, ROM, hard disk or optical or magnetic media. When software is used, any suitable programming language or platform can be used to implement the module.

More particularly, the motion sensors 110 can be configured to generate signals based on various aspects of movement and/or orientation of the SLAM device 100. For instance, the one or more motion sensors 110 can include an accelerometer and/or a gyroscope to determine the relative orientation of the SLAM device 100 as the SLAM device 100 is carried or transported through a space. Signals from the one or more motion sensors 110 can be used in combination with signals and information collected by the one or more depth sensors 130, and the one or more image capture device 140 to generate location data, depth data, and a three-dimensional map for the space.

The one or more image capture devices 140 (e.g. digital cameras) can be used to generate a sparse point cloud of data points associated with points on surfaces proximate to the SLAM device 100 as it is carried through the space. The sparse point cloud can include a plurality of data points associated with metadata providing the approximate location of the data point (e.g. the distance to the SLAM device 100) as well as a color or texture associated with the data point. The one or more image capture devices 140 can capture imagery (e.g. a video) of the space as the SLAM device 100 is carried through the space. The imagery can be then be processed (e.g. using structure-from-motion techniques and/or visual odometry) to identify and track features through the imagery. The tracked features can correspond to data points in the sparse point cloud.

The one or more depth sensors 130 can acquire a dense depth map indicative of the depth of surfaces proximate the SLAM device 100 as the SLAM device 100 is carried or transported through the space. The dense depth map can be of relatively high resolution and can be used to generate a three-dimensional map of a space. The one or more depth sensors 130 can include any suitable depth sensor, such as one or more laser range finders. In particular example embodiments, the one or more depth sensors 130 can include structured light devices capable of acquiring depth data for surfaces proximate the SLAM device 100 using structured light techniques. Structure light techniques can project a pattern (e.g. light pattern or infrared pattern) onto surfaces. Imagery captured of the pattern by the one or more image capture devices 140 can be analyzed to identify the dense depth map.

The sparse point cloud can be analyzed by a localization module 152 in conjunction with signals received from the one or more motion sensors 110 to identify the location of the device in the space. For instance, the sparse point cloud can be registered against previously acquired data associated with the space to determine the approximate location of the SLAM device 100 as it is carried through the space. The signals from the motion sensors 110 can be used to refine the location and orientation of the SLAM device 100 in the space. A mapping module 154 can coordinate the high resolution depth data acquired by the depth sensors 130 with the location data determined by the location module 152 to generate a three-dimensional representation or map of the geometry of the space and any objects located in the space.

The three-dimensional map and location data can be refined using relocalization techniques. For instance, the SLAM device 100 can recognize that it has visited a location in the interior space that the SLAM device 100 has previously visited. The SLAM device 100 can align depth data collected by the SLAM device 100 based on the realization that the device has previously visited the same location. For instance, depth data acquired at the location can be aligned with the previously collected depth data acquired at the location to provide a more accurate three-dimensional map of the space.

The data 160 collected and generated by the SLAM device 100 as it is carried or transported through the space can be stored in a memory. The data 160 can include, for instance, location data as determined by the location module 152, sparse point clouds obtained, for instance, by the one or more image capture devices 140, depth data obtained, for instance, by the one or more depth sensors 130, and geometry data generated, for instance, by the mapping module 154.

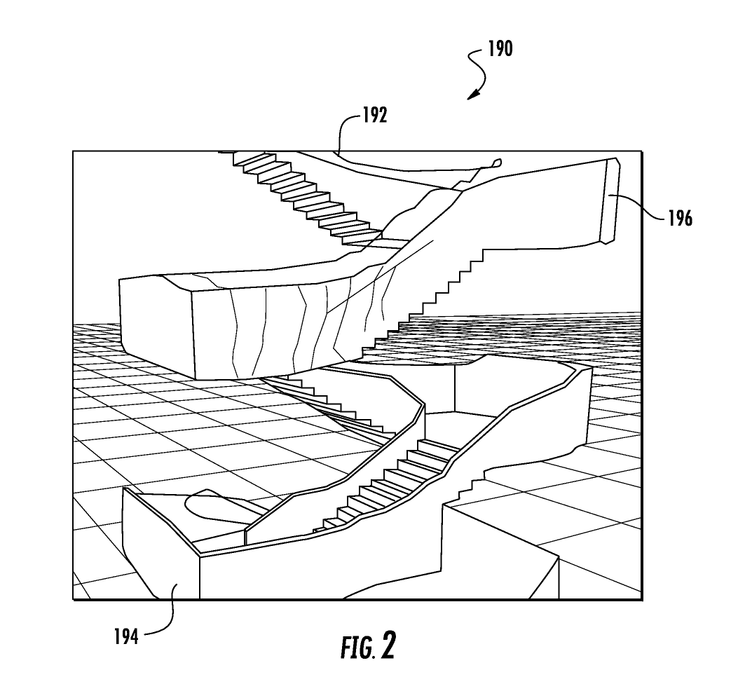

FIG. 2 depicts a graphical representation of an example set of data 190 collected by a SLAM device 100 as it is carried through an interior space, such as a stairwell. For instance, the data 190 includes a trace 192 indicative of the location of the SLAM device 100 as it is carried through the stairwell. The trace 192 can be determined using localization techniques based on signals received from the motion sensors and/or the sparse point cloud collected by the SLAM device. The example set of data 190 further includes a dense depth map 194 collecting using one or more depth sensors. The dense depth map 194 can include a plurality of data points indicative of a location or depth to surfaces relative to the SLAM device 100 as it is carried through the stairwell. The dense depth map 194 and the location information represented by trace 192 can be combined to generate a three-dimensional map 196 of the stairwell as the SLAM device 100 is carried through the space.

The data 160 collected and generated by the SLAM device 100 can be used for a variety of purposes. In certain example embodiments, the data 160 can be communicated over a network 170 via a network interface to a remote computing device 180. The remote computing device 180 can include one or more processors and one or more memory devices including one or more tangible non-transitory computer-readable media storing computer-readable instructions that when executed by the one or more processors cause the one or more processors to perform operations, including generating and/or enhancing representations of interior spaces and/or training visual search applications.

### Example Methods for Generating and/or Enhancing Representation of an Interior Space

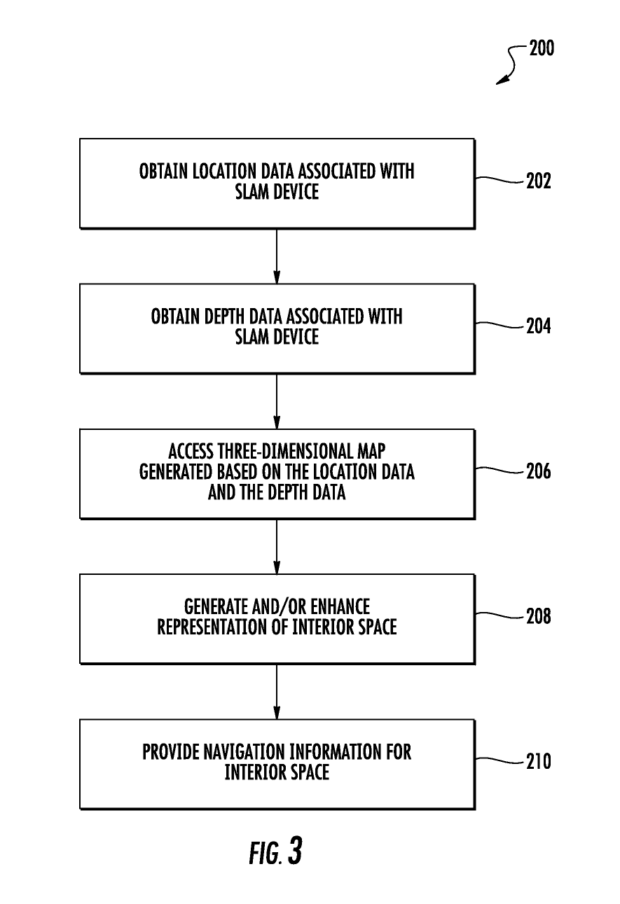

FIG. 3 depicts a flow diagram of an example method (200) for generating and/or enhancing a representation of an interior space according to example embodiments of the present disclosure. The method (200) can be implemented by one or more computing devices. In addition, FIG. 3 depicts steps performed in a particular order for purposes of illustration and discussion. Those of ordinary skill in the art, using the disclosures provided herein, will understand that various steps of any of the methods disclosed herein can be modified, omitted, rearranged, expanded, repeated and/or adapted in various ways without deviating from the scope of the present disclosure.

At (202), the method can include obtaining location data collected by a SLAM device. The location data can provide the location of the SLAM device as it is carried through a space. The location data can be generated using signals received from motion sensors on the SLAM device in addition to a sparse point cloud of data points generated using one or more images captured by the SLAM device.

At (204), the method includes obtaining depth data collected by the SLAM device. The depth data can provide the depth to surfaces proximate the SLAM device. The depth data can be a dense depth map acquired by various depth sensors on the SLAM device, such as laser range finders and/or structured light sensors.

At (206), a three-dimensional map of the interior space can be accessed. In some embodiments, the three-dimensional map can be generated based at least in part on the location data and the depth data by combining/coordinating the depth data with the location data. The three-dimensional map can provide data indicative of the geometry of the interior space and can be generated as the SLAM device is carried through the three-dimensional space.

At (208), the method includes generating and/or enhancing a representation of the interior space based at least in part on the data collected by the SLAM device, such as the location data, the depth data, and/or the three-dimensional map. In some embodiments, the data collected by the SLAM device can be used to augment interior space imagery (e.g. panoramic imagery) and/or to generate floor plans or other representations of the interior space. Example techniques for generating and/or enhancing representations of interior spaces according to example embodiments of the present disclosure will be discussed in detail below.

At (210), the method can also include providing navigation information to assist with navigation or obstacle avoidance in the interior space. For instance, the data collected by the SLAM device can be used to navigate a user or other carrier (e.g. robot, autonomous vehicle, etc.) through the interior space. Navigation information can be provided in any suitable manner. For instance, the navigation information can be provided in the form of control signals to control movement of robotics, autonomous vehicles, etc. In addition, navigation information can be provided to a user to assist a user carrying or otherwise transporting the SLAM device. In a particular implementation, the navigation information can be provided in tactile or audible form, for instance, to assist with navigation of the vision impaired.

More particularly, as a SLAM device is carried through the space, the data collected by the SLAM device can be registered against three-dimensional map data previously obtained, for instance, by one or more SLAM devices. For example, a sparse point cloud generated by the SLAM device can be registered against the three-dimensional map data. As a result, the precise location of the SLAM device relative to data points in the three-dimensional map data can be obtained. This information can be used to identify the precise location of the SLAM device relative to certain points of interest, furniture, and other objects in an interior space.

The information can be used to navigate a user or other device through the interior space. For instance, in one particular implementation, the data collected by the SLAM device can be used for obstacle avoidance. More particularly, registration of a sparse point cloud generated by a SLAM device against previously collected depth data can be used to assist with navigation of robotics, autonomous vehicles, and other devices in avoiding obstacles in an interior space. Control signals can be generated for controlling motion of the robotics, autonomous vehicles, and other devices based on the data collected by the SLAM device to avoid obstacles and to navigate the device through the interior space.

In another particular implementation, the data collected by the SLAM device can be used to assist with navigating a user, such as a vision-impaired individual, through the interior space. For instance, as the vision-impaired user carries the SLAM device through the interior space, the data collected by the SLAM device can be analyzed to identify the precise location of the user relative to objects and points of interest in the interior space. The SLAM device can provide tactile and/or audio signals to the user to signify to the user of the presence of an object in the user's current path. In this way, the SLAM device can be used to enhance the user's “vision” of the interior space.

### Augmenting Interior Space Data Collection with Data Collected by Device Capable of Simultaneous Localization and Mapping

According to example embodiments of the present disclosure, the data collected by a SLAM device can be used to pose and generate depth data for images captured of an interior space. For instance, the data collected by the SLAM device can be used to estimate the relative positions and orientations of images captured of an interior space and to estimate the geometry of the environment depicted in the panoramic images. This information can be used to construct immersive three-dimensional panoramic imagery of the interior space to be used, for instance, in a geographic information system.

More particularly, existing techniques for capturing panoramic images of interior spaces can include capturing imagery of building interiors using sophisticated DSLR (digital single-lens reflex) image capture devices. The images can be captured by mounting the DSLR image capture devices on a tripod and panning, rotating, and tilting the DSLR image capture devices relative to the interior space. Due to the large parallax that can be exhibited by the imagery captured by the DSLR image capture devices, robustly estimating the pose of each image can be a difficult problem. For instance, a moderation tool may have to be used to manually correct the estimated image locations, which can be a time consuming, imprecise, and difficult task. Moreover, to generate immersive panoramic images from the panoramic imagery captured by DSLR image capture devices, the geometry of the environment depicted in the images needs to be estimated. This can require a team of moderators to manually annotate the geometry of the environment, another challenging and time consuming task.

A SLAM device capable of simultaneous localization and mapping can be used in conjunction with the DSLR image capture devices to generate immersive panoramic imagery of an interior space. In one example embodiment, a SLAM device can be mounted to a DSLR image capture device. For instance, as shown in FIG. 3, a SLAM device 310 can be mounted to a DSLR camera 320. The SLAM device 310 can obtain depth data for the scene 300 as the DSLR camera 320 captures digital imagery of the scene 300. The SLAM device 310 can also be used to obtain location data associated with the location and orientation of the SLAM device 310 as the DSLR camera 320 captures imagery of the scene.

The location data collected by the SLAM device 310 can be used to track the location of the DSLR camera 320 through the collection of images. A post-processing stage can analyze this location data to determine the position and orientation of the DSLR 320 when images for generating the panoramas were captured. A three-dimensional map of the environment can also be generated from the depth data collected by the SLAM device 310. The depth values provided by the three-dimensional map can be back-projected into the image plane of each image to compute depths for each pixel in the captured images.

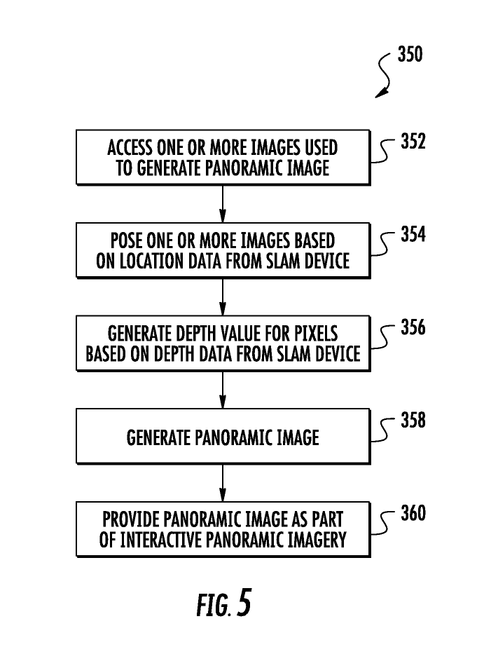

FIG. 5 depicts a flow diagram of an example method (350) for generating panoramic images according to example aspects of the present disclosure. At (352), the method can include accessing one or more images used to generate a panoramic image. The one or more images can be captured of the interior space using a digital camera, such as a DSLR camera or a digital camera associated with a SLAM device.

At (354), the method includes posing the one or more images based at least in part on the location data obtained from a SLAM device. Posing one or more images can refer to determining a position and orientation of a camera capturing the image relative to a reference. The pose of the one or more images can be determined by coordinating the captured images with location data acquired by the one or more SLAM devices. For instance, time stamps between the captured images and the location data can be coordinated to determine the pose of the one or more images.

At (356), the method can include generating a depth value for one or more pixels of the one or more images based on the depth data acquired by the SLAM device. More particularly, the depth data can be back-projected into the image plane of each image to compute depths for each pixel in the images used to generate the panorama. The depth data can be identified for particular pixels based on the location data obtained by the SLAM device.

At (358), the method can include generating a panoramic image from the captured images. For instance, various image stitching techniques can be used to stitch the captured images together to provide a panoramic image of the interior space. At (360), the panoramic image can be provided as part of interactive panoramic imagery of an interior space provided, for instance, by a geographic information system that stores and indexes data according to geographic coordinates of its elements. Interactive panoramic imagery can allow a user to navigate the panoramic imagery to view the imagery of the interior space from a plurality of different viewpoints. For instance, a geographic information system, such as a mapping service or virtual globe application, can allow a user to rotate, tilt, zoom, pan or otherwise navigate a virtual camera to view the panoramic imagery from different perspectives.

### Floor Plan Generation

According to other example embodiments of the present disclosure, the data collected by a SLAM device can be used to generate floor plans, models of interior spaces, representations of furniture and other objects in interior spaces, and for other purposes. For example, in one embodiment, the data collected by the SLAM device can be analyzed to generate a two-dimensional or a three-dimensional floor plan of an interior space. For instance, the two-dimensional or three-dimensional map generated by the SLAM device can include data associated with a dense depth map representative of the geometry of the space. The dense depth map can be analyzed using various processing techniques to generate a floor plan of the interior space. The floor plan can provide a simplified representation of the space relative to the three-dimensional map generated by the SLAM device.

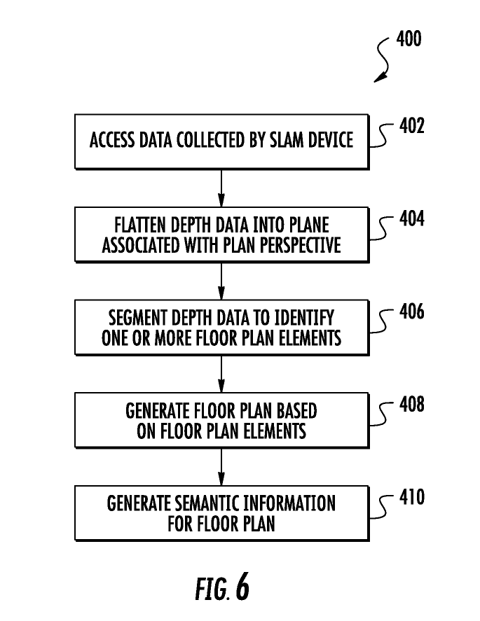

FIG. 6 depicts a flow diagram of one example method (400) of generating a floor plan based at least in part on data collected by a SLAM device according to example aspects of the present disclosure. At (402), the method includes accessing depth data collected by the SLAM device. For instance, the depth data and/or three-dimensional map collected by the SLAM device can be accessed for generating a floor plan of the interior space. The depth data and/or three-dimensional map can be collected by the SLAM device as the SLAM device is carried through the interior space.

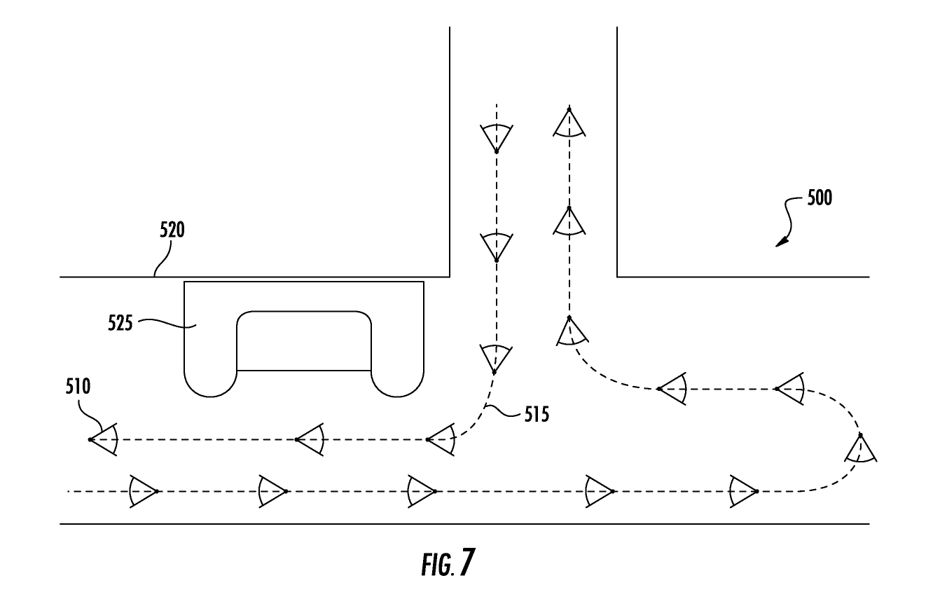

For instance, FIG. 7 depicts a representation of an example SLAM device 510 being carried or transported through an interior space 500 along a path 515. As shown, the SLAM device 510 can capture imagery and depth data from a plurality of different perspectives of the interior space 500. The depth data can be used to generate a dense depth map representative of the geometry of the interior space 500. For instance, the depth data can provide geometry for objects in the interior space 500, such as an item of furniture 525 and walls 520.

At (404) of FIG. 6, the depth data can be flattened so that the depth data is associated with a plane viewed from a plan perspective, such as a top-to-bottom perspective and/or a bottom-to-top perspective. More particularly, the dense depth map can be flattened and associated with either a top-to-bottom perspective (e.g. looking towards the floor of the interior space) or a bottom-to-top perspective (e.g. looking towards the ceiling).

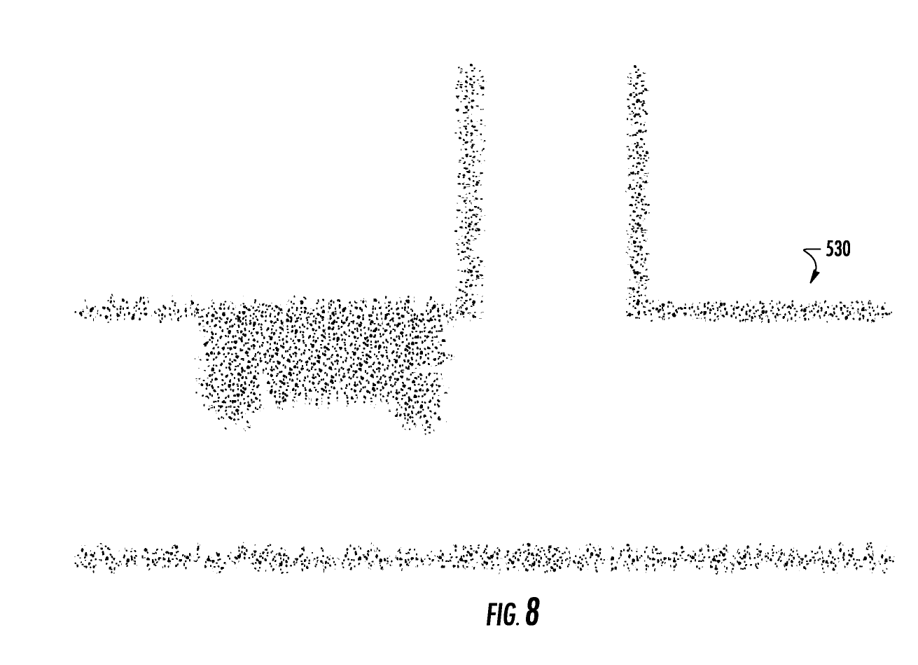

FIG. 8 depicts an example dense depth map 530 obtained by the SLAM device 510 as it is carried or transported through the interior space 500 of FIG. 7. The depth map 530 can include a plurality of data points modeling the geometry of the interior space 500. As shown, the dense depth map 530 can be flattened and analyzed from a top-to-bottom perspective.

At (406) of FIG. 6, the method can include segmenting the depth data to identify one or more floor plan elements. For instance, data points in the dense depth map 530 of FIG. 8 can be clustered to identify representations of walls, furniture, and other objects in the space. For instance, a naïve approach to analyzing the dense depth 530 can include using a RANSAC process to fit hypothetical walls to the dense depth map 530. The hypothetical walls can be used to construct a floor plan of the interior space.

More complex analysis techniques can be used without deviating from the scope of the present disclosure. For example, surface normals determined from data points in the dense depth map can be identified and used to identify the locations of walls and other features in the interior space. As another example, eigenvector decomposition techniques can be used to identify dominant vectors associated with clusters of data points. The dominant vectors can be used to identify objects (e.g. walls) in the space for generation of a floor plan. As yet another example, machine learning approaches can be employed to generate floor plans based on genre specific heuristics. As more dense depth maps are analyzed to generate floor plans, additional heuristics for floor plan generation can be developed and employed to generate increasingly accurate two-dimensional or three-dimensional floor plans from the dense depth maps collected by SLAM devices.

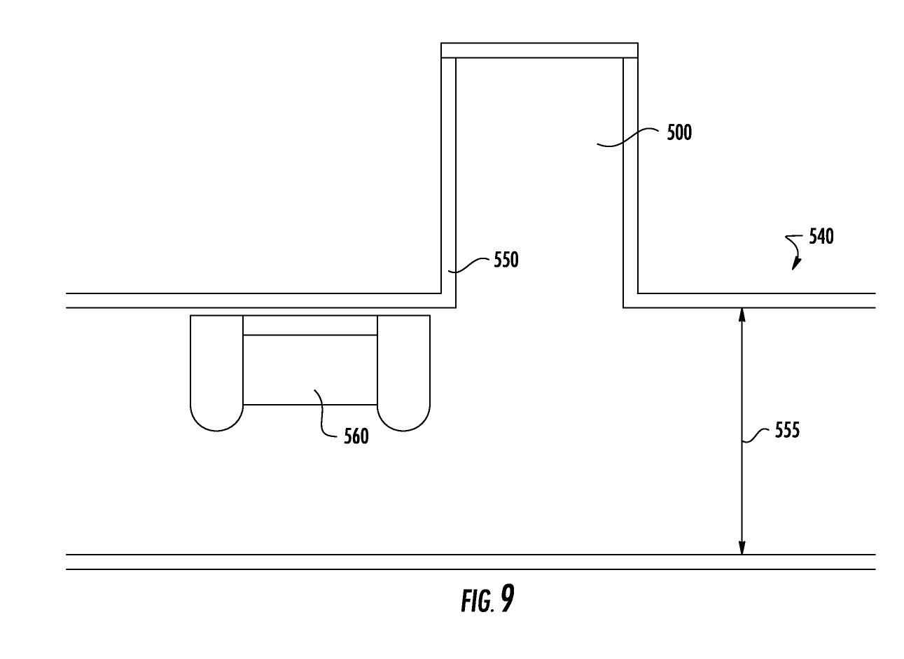

At (408) of FIG. 6, the method can include generating a floor plan based on the floor plan elements. FIG. 9 depicts an example floor plan 540 that can be generated from the dense depth map 530 of FIG. 8 according to example aspects of the present disclosure. As shown, the example floor plan 540 can provide a simplified representation of the interior space 400 and can include two-dimensional representations of walls 550 and other objects in the interior space 500. Once generated, the floor plans can be used for a variety of purposes. For instance, the floor plans can be used in real estate, architecture, survey, repair, or planning purposes. As an example, the generated floor plans can be used to identify emergency exit paths through the interior space. In addition, the generated floor plans can be used to implement a virtual tape measure that allows a user to obtain a distance between two objects (e.g. two walls) using the data collected by the SLAM device. For instance, as shown in FIG. 9, the distance 555 between two walls can be determined from the generated floor plan 540.

According to yet further embodiments of the present disclosure, the data collected by a SLAM device can be used for semantic floor plan generation. More particularly, as shown at (410) of FIG. 6, the method can include generating semantic information for the floor plan. Semantic floor plans can provide additional semantic information, such as the names of rooms, locations of objects (e.g. furniture) in the rooms, and other information. For instance, as shown in FIG. 9, the floor plan 540 can include information such as the name HALLWAY. More particularly, the data collected by the SLAM device can be processed to identify specific items in the interior space (e.g. couches, sinks, etc.). The identified items can be used to generate and provide semantic information to provide to a user.

For instance, the data collected by the SLAM device can be analyzed to identify a particular object in a space. More particularly, models for objects can be developed using machine learning techniques. These models can be accessed and used to identify whether a particular cluster of data points in a dense depth map collected by a SLAM device is associated with a particular type of object. Once identified, a representation of the particular type of object can be generated and provided in conjunction with the floor plan. For instance, as shown in FIG. 9, a vector representation 560 of the furniture 525 can be provided in conjunction with the floor plan 540.

The names or types of rooms can also be inferred or determined from the types of objects in the space identified from the data collected by the SLAM device. For instance, a room containing items identified as a couch and a chair can be determined to be a living space. A room having long parallel walls can be determined to be a hallway. A room containing items identified as a sink and a shower can be determined to be a bathroom. Semantic information associated with names and/or types of rooms can be provided in conjunction with a floor plan generated according to aspects of the present disclosure

The data collected by the SLAM device can also be analyzed to generate detailed models of objects found in a space. For instance, an interior space may contain many identical objects, such as a plurality of identical chairs. The data collected by the SLAM device can capture geometry associated with different identical objects from many different perspectives as the SLAM device is carried through the space. This data can be combined to generate a three-dimensional model of the object. This three-dimensional model can then be used as a representation of the item everywhere the items exists in the space.

### Training a Visual Search Application

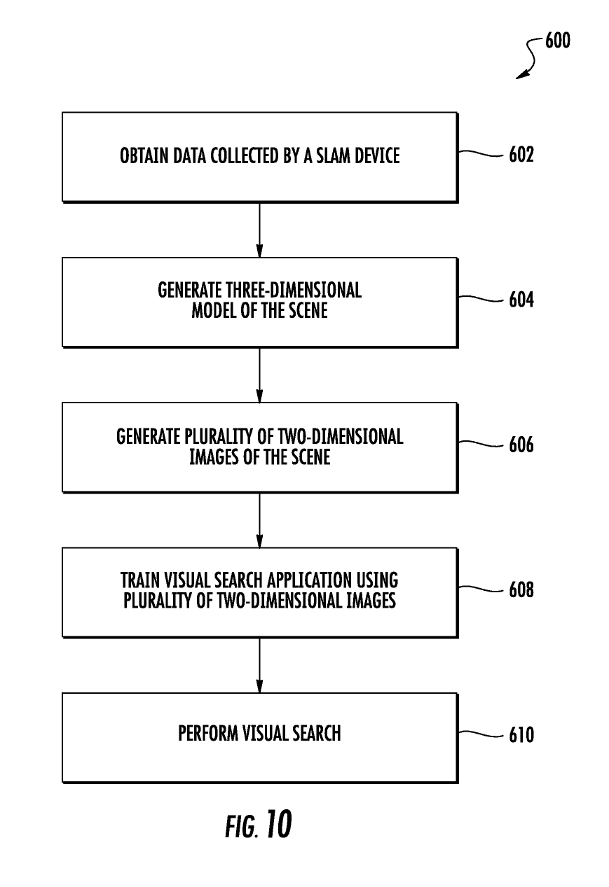

FIG. 10 depicts a flow diagram of an example method (600) for training a visual search application. At (602), the method can include obtaining data associated with a scene collected by a SLAM device. More particularly, data such as three-dimensional depth data and digital images acquired by the SLAM device as the SLAM device is carried through the scene can be accessed. The data can include a plurality of images and depth data from a variety of different perspectives of the scene. In particular example implementations, data from multiple passes of the SLAM device through the scene or from multiple SLAM devices can be accessed. As will be discussed in detail below, this imagery and depth data can be processed to generate a three-dimensional model of the scene, including a three-dimensional representation of an object.

At (604) of FIG. 10, the method can include generating a three-dimensional model from the data collected by the SLAM device. For instance, the three-dimensional depth data of the scene can be used to generate a polygon mesh modeling the scene. The polygon mesh can include a plurality of polygons (e.g. triangles) used to model the surfaces of objects in the scene. The polygon mesh can be generated, for instance, by merging depth data acquired from the SLAM device from multiple different perspectives. The imagery captured by the SLAM device can be texture mapped to the polygon mesh. In this way, a three-dimensional representation of the scene can be generated from the data collected by the SLAM device.

At (606), the method can include generating a plurality of two-dimensional images of the scene from the three-dimensional model. More particularly, the three-dimensional model can be viewed from a plurality of different virtual camera perspectives. The three-dimensional model can be projected onto an image plane associated with the virtual camera perspective to generate the two-dimensional image of the scene. Many different two-dimensional images of the scene from many different perspectives can be generated in this manner.

At (608), the method can include training a visual search application using the plurality of two-dimensional images. A variety of techniques can be used to train the visual search application. In one example implementation, feature identification techniques can be performed on the plurality two-dimensional images of the scene to identify prominent features in the scene. The identified features can be stored in a database associated with the visual search application. Information can be associated with the identified features, for instance, a geographic information system database.

At (610), the method can include performing a visual search using the visual search application. The visual search can be performed by receiving an input image via, for instance, a suitable user interface. For instance, a user of a mobile device can capture an image of a scene and submit the image to the visual search application. Feature matching techniques can be used to match one or more features in the input image with one or more of the features depicted in the two-dimensional images used to train the visual search application. Once the features are matched, information associated with the matched features can be accessed and provided to a user.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method, comprising:
obtaining, by one or more computing devices, location data indicative of a location of a mobile device in an interior space, the location data determined based on one or more motion sensors associated with the mobile device and a sparse point cloud obtained by the mobile device, the sparse point cloud based on tracking one or more features identified in the interior space;
obtaining, by the one or more computing devices, depth data indicative of the location of one or more surfaces proximate the mobile device, the depth data acquired by the mobile device using one or more depth sensors; and
generating, by the one or more computing devices, a visual representation of an interior space based on the location data and the depth data,
wherein generating the visual representation of an interior space comprises generating, by the one or more computing devices, a two-dimensional floor plan for the interior space,
wherein generating a floor plan for the interior space comprises flattening, by the one or more computing devices, the depth data acquired by the mobile device into a plane associated with one or more of a top-to-bottom perspective or a bottom-to-top perspective, and
wherein generating a floor plan for the interior space comprises identifying, by the one or more computing devices, a portion of the depth data as belonging to an object in the interior space by comparing the portion of the depth data to a model of the object, and representing the object in the floor plan with a three-dimensional model of the object.

2. The computer-implemented method of claim 1, wherein the one or more computing devices comprises the mobile device.

3. The method of claim 1, wherein the visual representation of an interior space is generated based on a three-dimensional map of the interior space generated by combining the location data and the depth data.

4. The method of claim 3, further comprising providing, by the one or more computing devices, navigation information determined based on the three-dimensional map.

5. (canceled).

6. The computer-implemented method of claim 1, wherein generating, by the one or more computing devices, a floor plan for the interior space further comprises:
segmenting, by the one or more computing devices, the depth data to identify one or more floor plan elements; and
generating, by the one or more computing devices, the floor plan of the interior space based on the one or more floor plan elements.

7. The computer-implemented method of claim 1, wherein the method further comprises generating semantic information for the floor plan.

8. The computer-implemented method of claim 7, wherein generating the semantic information comprises determining, by the one or more computing devices, a semantic identifier for a floor plan element in the interior space.

9. The method of claim 1, wherein the generating, by the one or more computing devices, a floor plan for the interior space comprises:
generating, by the one or more computing devices, a vector representation of the object for use in the floor plan.

10. The method of claim 1, wherein generating, by the one or more computing devices, a visual representation of the interior space comprises generating, by the one or more computing devices, a panoramic image of the interior space.

11. The method of claim 10, wherein generating, by the one or more computing devices, a panoramic image captured of an interior space, comprises posing, by the one or more computing devices, one or more images of the interior space used to generate the panoramic image based on the location data.

12. The method of claim 10, wherein generating, by the one or more computing devices, a panoramic image captured of an interior space comprises generating, by the one or more computing devices, a depth value for one or more pixels for the panoramic image based on the depth data acquired by the mobile device.

13. The method of claim 10, wherein the panoramic image is provided as part of interactive panoramic imagery of an interior space provided in a geographic information system.

14. A computing system, comprising:
one or more processors; and
one or more memory devices, the one or more memory devices storing computer-readable instructions that when executed by the one or more processors cause the one or more processors to perform operations, the operations comprising:
obtaining location data indicative of a location of a mobile device in an interior space, the location data determined based on one or more motion sensors associated with the mobile device and a sparse point cloud obtained by the mobile device, the sparse point cloud based on tracking one or more features identified in the interior space;
obtaining depth data indicative of the location of one or more surfaces proximate the mobile device, the depth data acquired by the mobile device using one or more depth sensors; and
generating a visual representation of an interior space based on the location data and the depth data,
wherein generating the visual representation of an interior space comprises generating a two-dimensional floor plan for the interior space, and
wherein generating a floor plan for the interior space comprises flattening the depth data acquired by the mobile device into a plane associated with one or more of a top-to-bottom perspective or a bottom-to-top perspective, and
wherein generating a floor plan for the interior space comprises identifying a portion of the depth data as belonging to an object in the interior space by comparing the portion of the depth data to a model of the object, and representing the object in the floor plan with a three-dimensional model of the object.

15. The computing system of claim 14, further comprising:
accessing one or more images of an interior space, the one or more images being captured of the interior space using a digital camera;
posing the one or more images of the interior space based on the location data; and
generating a depth value for one or more pixels based on the depth data acquired by the mobile device; and
generating a panoramic image from the one or more images based on the location data and the depth data.

16. The computing system of claim 15, wherein the panoramic image is provided as part of interactive panoramic imagery of an interior space provided in a geographic information system.

17. One or more tangible, non-transitory computer-readable media storing computer-readable instructions that when executed by one or more processors cause the one or more processors to perform operations, the operations comprising:
obtaining location data indicative of a location of a mobile device in an interior space, the location data determined based on one or more motion sensors associated with the mobile device and a sparse point cloud obtained by the mobile device, the sparse point cloud based on tracking one or more features identified in the interior space;
obtaining depth data indicative of the location of one or more surfaces proximate the mobile device, the depth data acquired by the mobile device using one or more depth sensors; and
generating a two-dimensional floor plan for the interior space based on the location data and the depth data,
wherein the operation of generating a floor plan for the interior space comprises flattening the depth data acquired by the mobile device into a plane associated with one or more of a top-to-bottom perspective or a bottom-to-top perspective, and
wherein the operation of generating a floor plan for the interior space comprises identifying a portion of the depth data as belonging to an object in the interior space by comparing the portion of the depth data to a model of the object, and representing the object in the floor plan with a three-dimensional model of the object.

18. The one or more tangible, non-transitory computer-readable media of claim 17, wherein the operation of generating a floor plan for the interior space further comprises:
segmenting the depth data to identify one or more floor plan elements; and
generating the floor plan of the interior space based on the one or more floor plan elements.

19. The one or more tangible, non-transitory computer-readable media of claim 18, wherein the operations further comprise generating semantic information for the floor plan.

20. The one or more tangible, non-transitory computer-readable media of claim 18, wherein the operation of generating a floor plan for the interior space comprises:
generating, by the one or more computing devices, a vector representation of the object for use in the floor plan.
